(19) United States
(12) Patent Application Publication
(10) Pub. No.: US 2017/0211020 A1
(43) Pub. Date: Jul. 27, 2017

(54) Glassware Corrosion Reduction

(71) Applicant: Reckitt Benckiser (Brands) Limited, Slough (GB)

(72) Inventors: Judith Preuschen, Heidelberg (DE); Michael Zahner, Heidelberg (DE); Markus Schilling, Heidelberg (DE)

(21) Appl. No.: 15/325,033

(22) PCT Filed: Jul. 16, 2015
(86) PCT No.: PCT/GB2015/052057

§ 371 Date: Jan. 9, 2017

(30) Foreign Application Priority Data
Jul. 16, 2014 (GB) 1412604.9

(51) Int. Cl. C11D 3/00; C11D 1/66; A47L 15/46; C11D 3/20; C11D 3/395; C11D 11/00; C11D 3/39

(52) U.S. Cl. CPC C11D 3/0073; C11D 11/0035; C11D 1/66; C11D 3/3942; C11D 3/2089; C11D 3/3945; C11D 3/395; A47L 15/46

(57) ABSTRACT

The invention provides a method of automatic dishwashing, comprising supplying an automatic dishwasher detergent composition to an automatic dishwasher and washing glassware in the dishwasher, wherein the detergent composition comprises a compound comprising an anion of Formula 1: wherein R is selected from the group consisting of: —H; —CH₃—CₙH₂ₙCH₃; —CH₂OH; —CₙH₂ₙCOOH; —CₙH₂ₙCOO; —CₙH₂ₙSO₃H; —CₙH₂ₙSO₃; —CₙH₂ₙNH₂; —CₙH₂ₙNHR′; —CₙH₂ₙNR′₂; —NHC(═O)—R′; and —CH₂PO(OR′)₂; wherein n>1; and R′ is H, alkyl or aryl. The invention also provides the use of this composition to reduce glassware corrosion during an automatic dishwasher wash cycle.

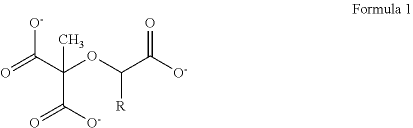

### BACKGROUND

In recent years there has been an ever increasing trend towards safer and environmentally friendly detergent compositions. This has led to the development of alternative complexing agents (builders), which are used instead of predominantly phosphorous based builders. Phosphate builders have been connected with eutrophication issues.

On the other hand phosphates can bind calcium and magnesium ions, can act as alkalinity source for the detergent, and are used to buffer the wash liquor in a dishwasher above pH 9 together with other chemicals such as disilicate, metasilicates and soda. Phosphates are also able to disperse existing calcium carbonate in the wash liquor to prevent ‘spotting’ on glassware.

Thus, replacing phosphates in a detergent requires compensating at least four different functions in an alkaline detergent, namely (1) providing alkalinity; (2) buffering capacity; (3) complexing of magnesium and calcium ions; and (4) dispersing capacity of calcium carbonate.

To overcome this problem of finding an alternative to sodium tripolyphosphate (STPP), organic molecules such as citrate have been identified. Citrate has the advantage that it is biodegradable and is widely available. It is a crystalline material that can be easily purified. The disadvantage is that the washing performance is poorer compared to phosphates, especially with hard water.

On the other hand, methyl-glycine-diacetic acid and salts thereof (collectively referred to herein as MGDA) are builders used commercially in phosphate-free automatic dishwashing (ADW) compositions and offer good cleaning performance, especially with hard water.

A recently discovered drawback to the use of MGDA in ADW compositions is the effect it has on glassware in soft water.

Glassware gradually corrodes under the warm alkaline conditions in soft water of the dishwashing cycle. Without wishing to be bound by theory is it believed that these conditions leach/extract minerals and ions from the glass surface, gradually weakening and marking it over many washes. MDGA-based compositions have been shown to exacerbate this effect in comparison to phosphate. This is believed to be due to its powerful binding/complexing effects with ions and minerals, especially zinc.

WO 2010/043854 discloses ADW compositions containing certain polycarboxylate derivatives which show good cleaning performance. However, in this document, the effect on glassware was not tested and the preferred water supply was a hard water supply.

DE 2,304,404 discloses ADW compositions comprising a low foaming surfactant, a source of chlorine and a polycarboxylate ether, for example trisodium-2-oxa-butane-1,1,3-tricarboxylate. Sodium silicate is preferably also included in the composition.

U.S. Pat. No. 4,228,300 discloses detergent compositions comprising similar polycarboxylate ethers, including trisodium 3-oxa-2,2,4-pentanetricarboxylate. The tests described are laundry tests and the effect on glassware in automatic dishwashing is not discussed.

It is the object of the present invention to address the above problem: to provide excellent phosphate-free builder performance without concomitant glassware corrosion, especially in soft water.

### SUMMARY OF THE INVENTION

According to a first aspect of the present invention there is provided a method of automatic dishwashing, comprising supplying an automatic dishwasher detergent composition to an automatic dishwasher and washing glassware in the dishwasher, wherein the detergent composition comprises a compound comprising an anion of Formula 1:

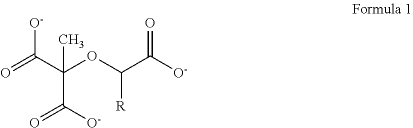

wherein R is selected from the group consisting of: —H; —CH₃; —CₙH₂ₙCH₃; —CₙH₂ₙOH; —CₙH₂ₙCOOH; —CₙH₂ₙCOO; —CₙH₂ₙSO₃H; —CₙH₂ₙSO₃; —CₙH₂ₙNH₂; —CₙH₂ₙNHR′; —CₙH₂ₙNR′₂; —NHC(═O)—R′; and —CₙH₂ₙPO(OR′)₂;
wherein n≧1; and R′ is H, alkyl or aryl.

Preferably, said compound is an alkali metal or ammonium salt of the anion of Formula 1, preferably sodium or potassium, preferably sodium. Preferably, the water supplied to the dishwasher and used in the dishwashing cycle has a hardness of 9 degrees German hardness or less.

In a second aspect of the invention there is provided the use of an automatic dishwasher detergent composition, comprising a compound comprising an anion of Formula 1, to reduce corrosion of glassware during an automatic dishwasher wash cycle.

The compound comprising an anion of Formula 1 may be a compound of Formula 2:

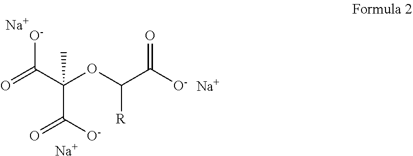

wherein R is selected from the group consisting of —H, —CH₃, —CₙH₂ₙCH₃, —CₙH₂ₙOH, —CₙH₂ₙCOOH, —CₙH₂ₙSO₃H, —CₙH₂ₙNH₂, —CₙH₂ₙNHR′, —CₙH₂ₙNR′₂, —NHC(═O)—R′ and —CₙH₂ₙPO(OR′)₂;
wherein n≧1; and R′ is H, alkyl or aryl.

Alternatively, the sodium counterions as shown in Formula 2 may be replaced by other positive counterions, such as, but not limited to, other alkali metals.

### DETAILED DESCRIPTION

Unless specifically stated or the context otherwise requires, embodiments described herein apply equally to all aspects of the invention. Percentages quoted are by weight unless otherwise stated or the context otherwise requires.

Unexpectedly it has been found that certain phosphate-free builders, comprising an anion of Formula 1, provide substantial benefits in terms of a reduction in glassware corrosion compared with a known P-free builder, MGDA.

For the purposes of the present invention, glassware corrosion may mean any damage to glassware, including but not limited to surface glaze decoration, line clouding, surface etching or pitting or iridescence.

### Builder

Preferably, in Formulas 1 and 2, one or combinations of the following criteria apply:
R is not H;
R is not —CₙH₂ₙPO(OR′)₂;
R is selected from the group consisting of —H, —CH₃, —CₙH₂ₙCH₃, —CₙH₂ₙOH, —CₙH₂ₙCOOH, —CₙH₂ₙSO₃H, —CₙH₂ₙNH₂, —CₙH₂ₙNHR′, —CₙH₂ₙNR′₂, —NHC(═O)—R′, and —CₙH₂ₙPO(OR′)₂;
R is selected from the group consisting of —CH₃, —CₙH₂ₙCH₃, —CₙH₂ₙOH, and —CₙH₂ₙCOOH;
n is 1 to 5, preferably 1, 2 or 3;
R′ is H or alkyl, preferably C₁₋₅ alkyl, preferably C₁₋₃ alkyl, preferably methyl or ethyl;

More preferably, R is CH₃.

The compound comprising an anion of Formula 1 preferably further comprises a cation which is an alkali metal or ammonium cation, preferably sodium or potassium ion, preferably sodium ion. In an embodiment, the compound is a tri- or tetra-sodium salt of the anion of Formula 1. Most preferably, R is CH₃ and the compound is the trisodium salt.

In an embodiment, the ADW composition used in the invention comprises at least 1 wt %, at least 5 wt %, at least 7 wt %, at least 10 wt %, at least 15 wt %, at least 20 wt %, at least 25 wt %, at least 30 wt %, or at least 32 wt %, of the compound comprising an anion of Formula 1/compound of Formula 2. Preferably, the ADW composition comprises up to 90 wt %, up to 85 wt %, up to 80 wt %, up to 75 wt %, up to 70 wt %, up to 65 wt %, up to 60 wt %, up to 55 wt %, up to 50 wt %, up to 45 wt %, up to 40 wt %, or up to 35 wt %, of the compound comprising an anion of Formula 1/compound of Formula 2. It is an advantage of the invention that, especially in soft water conditions, it has been found that a lower amount of the compound comprising an anion of Formula 1/compound of Formula 2 can be used effectively.

### Co-Builder

The ADW detergent composition used in the present invention may comprise a further builder, hereinafter co-builder.

Where a co-builder(s) is present, it is preferably present in the composition in an amount of at least 2 wt %, at least 3 wt %, at least 4 wt %, or at least 5 wt %. It is preferably present in the composition in an amount of up to 40 wt %, up to 35 wt %, up to 30 wt %, up to 25 wt %, up to 20 wt %, or up to 15 wt %.

Co-builders which are organic are preferred, and include homopolymers and copolymers of polycarboxylic acids and their partially or completely neutralized salts, additional monomeric polycarboxylic acids and hydroxycarboxylic acids and their salts, phosphates and phosphonates, and mixtures of such substances. Preferred salts of the abovementioned compounds are the ammonium and/or alkali metal salts, i.e. the lithium, sodium, and potassium salts, and particularly preferred salts are the sodium salts.

In a further embodiment the organic co-builder is a biodegradable polymer.

An exemplary suitable polycarboxylic acid is the homopolymer of acrylic acid. A further suitable polycarboxylic acid is poly-aspartic acid, namely polymers containing monomer units derived from aspartic acid of the formula

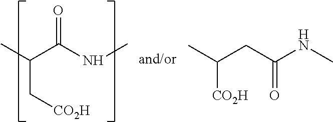

A yet further suitable organic co-builder is a sulfonated polymer. Preferred examples of suitable sulphonated polymers include copolymers of CH₂═CR¹—CR²R³—O—C₄H₃R⁴—SO₃X wherein R¹, R², R³, R⁴ are independently 1 to 6 carbon alkyl or hydrogen, and X is hydrogen or alkaline metal with any suitable other monomer units including acrylic, modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulfonated monomers for incorporation in the composition include sulphonated (co)polymers such as 2-acrylamido-2-methyl-1-propanesulfonic acid, 2-methacrylamido-2-methyl-1-propanesulfonic acid, 3-methacrylamido-2-hydroxy-propanesulfonic acid, allysulfonic acid, methallysulfonic acid, 2-hydroxy-3-(2-propenyloxy) propanesulfonic acid, 2-methyl-2-propenen-1-sulfonic acid, styrenesulfonic acid, vinylsulfonic acid, 3-sulfopropyl acrylate, 3-sulfopropylmethacrylate, sulfomethylacrylamide, sulfomethylmethacrylamide and water soluble salts thereof. It is especially preferred that the sulphonated polymer comprises 2-acrylamido-2-methyl-1-propanesulfonic acid.

Suitable sulfonated polymers are also described in U.S. Pat. No. 5,308,532 and in WO 2005/090541.

Sulfonated polymers are used in detergency applications as polymers to disperse Ca-phosphate compounds and prevent their deposition. Surprisingly, we have found such polymers to give cleaning benefits in combination even with preferred phosphorus-free compositions of the present invention.

Other suitable co-builders are disclosed in WO 95/01416, to the contents of which express reference is hereby made.

Although phosphorus-containing cobuilders may be present in this invention, preferred compositions are substantially free of phosphates, preferably substantially free of phosphorous-containing compounds. By this is meant that the compositions do not comprise more than 5 wt % phosphate/phosphorous-containing compounds, preferably not more than 1 wt % phosphate/phosphorus-containing compound(s).

Preferably, the composition contains no phosphate/phosphorus-containing compounds.

It has been found that the builder that is the main focus of this invention is very effective in ADW applications, even when using soft water. Thus, although the ADW composition used herein may further comprise a co-builder such as MGDA or citrate or mixtures thereof, it need not do so. In an embodiment, the composition comprises no MGDA. In an embodiment, it comprises no citrate. Alkaline co-builders such as carbonate and bicarbonate may still be useful for the purpose of controlling the pH of the formulation. In an embodiment, the composition comprises no other builder except for a carbonate, bicarbonate, and/or sulphonated polymer.

### Surfactant

Preferably the ADW composition used in the invention further comprises a surfactant, more preferably up to 7.5 wt %, up to 7.0 wt %, up to 6.0 wt %, up to 5.0 wt %, up to 4.0 wt %, or up to 3.5 wt % of surfactant. In an embodiment, it comprises from 0.05 to 7.5 wt % of a surfactant.

The surfactant comprised by the dishwasher detergent composition is preferably selected from anionic, non-ionic, cationic, amphoteric or zwitterionic surface active agents or mixtures thereof, most preferably non-ionic, cationic and amphoteric surfactants. Many such surfactants are described in Kirk Othmer's Encyclopedia of Chemical Technology, 3rd Ed., Vol. 22, pp. 360-379, “Surfactants and Detersive Systems”, incorporated by reference herein.

In general, non-ionic surfactants are preferred.

One possible class of nonionic surfactants are ethoxylated non-ionic surfactants prepared by the reaction of a monohydroxy alkanol with 6 to 20 carbon atoms with at least 3 moles, preferably at least 6 moles, more preferably at least 9 moles, further preferably at least 12 moles, particularly preferably at least 16 moles, and still more preferably at least 20 moles of ethylene oxide per mole of alcohol.

Particularly preferred non-ionic surfactants are the non-ionics from a linear chain fatty alcohol with 16-20 carbon atoms and at least 12 moles particularly preferred at least 16 and still more preferred at least 20 moles of ethylene oxide per mole of alcohol.

According to one preferred embodiment of the invention, the non-ionic surfactants additionally comprise propylene oxide (PO) units in the molecule. Preferably these PO units constitute up to 25% by weight, preferably up to 20% by weight and still more preferably up to 15% by weight of the overall molecular weight of the non-ionic surfactant. Particularly preferred surfactants are ethoxylated monohydroxy alkanols, which additionally comprises polyoxyethylene-polyoxypropylene block copolymer units. The alcohol portion of such surfactants constitutes more than 30%, preferably more than 50%, more preferably more than 70% by weight of the overall molecular weight of the non-ionic surfactant.

Further preferred non-ionic surfactants are linear chain fatty alcohols with between 12-15 carbon atomes, between 4-12 ethylene oxide (EO) groups and between 2-6 propylene oxide (PO) groups per molecule.

Another class of suitable non-ionic surfactants includes reverse block copolymers of polyoxyethylene and polyoxypropylene and block copolymers of polyoxyethylene and polyoxypropylene initiated with trimethylolpropane.

Another preferred class of nonionic surfactant can be described by the formula:

R¹O[CH₂CH(CH₃)O]ₓ[CH₂CH₂O]_{y}[CH₂CH(OH)R²]

where R¹ represents a linear or branched chain aliphatic hydrocarbon group with 4-18 carbon atoms or mixtures thereof, R² represents a linear or branched chain aliphatic hydrocarbon rest with 2-26 carbon atoms or mixtures thereof, x is a value between 0.5 and 1.5 and y is a value of at least 15.

Another group of preferred nonionic surfactants are the end-capped polyoxyalkylated non-ionics of formula:

R¹O[CH₂CH(R³)O]ₓ[CH₂]ₖCH(OH)[CH₂]ⱼOR²

where R¹ and R² represent linear or branched chain, saturated or unsaturated, aliphatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R³ in the formula above can be different. R¹ and R² are preferably linear or branched chain, saturated or unsaturated, aliphatic hydrocarbon groups with 6-22 carbon atoms, where group with 8 to 18 carbon atoms are particularly preferred. For the group R³H, methyl or ethyl are particularly preferred. Particularly preferred values for x are comprised between 1 and 20, preferably between 6 and 15.

As described above, in case x>2, each R³ in the formula can be different. For instance, when x=3, the group R³ could be chosen to build ethylene oxide (R³═H) or propylene oxide (R³=methyl) units which can be used in every single order for instance (PO) (EO) (EC)), (EO) (PO) (EC)), (EO) (EO) (PO), (EO) (EO) (EC)), (PO) (EO) (PO), (PO) (PO) (EO) and (PO) (PO) (PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R¹O[CH₂CH(R³)O]ₓCH₂CH(OH)CH₂OR²

The use of mixtures of different nonionic surfactants is suitable in the context of the present invention for instances mixtures of alkoxylated alcohols and hydroxy group containing alkoxylated alcohols.

Other suitable surfactants are disclosed in WO 95/01416, to the contents of which express reference is hereby made. In a particularly preferred embodiment of the present invention, the surfactant comprised by the composition is nonionic wherein at least 50 wt % of the nonionic surfactant has a melting point of 35° C., preferably >40° C. Preferably this nonionic surfactant is selected from one or more hydroxyalkyl polyglycolethers and optionally endcapped polyalkylated alcohols having at least 30 alkyleneoxy groups and mixtures thereof.

In an embodiment at least 50 wt % of the non-ionic surfactant has a melting point>35° C.

### Enzyme

The ADW composition used in the invention as hereinbefore described may further comprise from 0.01 to 5 wt % of one or more enzymes, preferably selected from the group consisting of protease, amylase, cellulase, lipase, lipoxygenase, laccase, oxidases, tyrosinases, mannanases and peroxidase enzymes. Protease and/or amylase are preferred. In an embodiment, the enzyme(s) are in the form of granules.

Such enzymes are commercially available and sold, for example, under the registered trade marks Esperase, Alcalase and Savinase by Novo Industries A/S. Other examples include registered trade mark Eraser 3800D by DuPont. Desirably the enzyme(s) is/are present in the composition in an amount of from 0.01 to 3 wt %, especially 0.01 to 2 wt % enzyme granule. This refers to the amount of the commercial ingredient, not the active enzyme content.

### Bleach System

A bleach component may be present in the ADW composition used in the invention. When bleach is present, it is preferably present in the composition in an amount of at least 1 wt %, at least 2 wt %, at least 4 wt %, at least 5 wt %, at least 7 wt %, or at least 10 wt %. It is preferably present in the composition in an amount of up to 30 wt %, up to 25 wt %, or up to 20 wt %.

Preferably, the ADW composition comprises no chlorine-based bleach. In an embodiment, the ADW composition comprises a bleach selected from an inorganic peroxy compound, organic peracid and a salt thereof.

It is especially preferred according to the present invention that the detergent composition further comprises from 1 wt % to 30 wt % of a bleach component selected from inorganic peroxy-compounds and organic peracids and salts derived therefrom.

Examples of inorganic perhydrates are persulfates such as peroxymonopersulfate (KMPS), perborates or percarbonates. The inorganic perhydrates are normally alkali metal salts, such as lithium, sodium or potassium salts, in particular sodium salts. The inorganic perhydrates may be present in the detergent as crystalline solids without further protection. For certain perhydrates, it is however advantageous to use them as granular compositions provided with a coating which gives the granular products a longer shelf life.

The preferred percarbonate is sodium percarbonate of the formula 2Na₂CO₃.3H₂O₂. A percarbonate, when present, is preferably used in a coated form to increase its stability.

Organic peracids include all organic peracids traditionally used as bleaches, including, for example, perbenzoic acid and peroxycarboxylic acids such as mono- or diperoxyphthalic acid, 2-octyldiperoxysuccinic acid, diperoxydodecanedicarboxylic acid, diperoxy-azelaic acid and imidoperoxycarboxylic acid and, optionally, the salts thereof. Especially preferred is phthalimidoperhexanoic acid (PAP).

Where bleach is present in a composition of the present invention, the composition may also comprise one or more bleach activators. These activators are preferably used in detergents for dishwashing cycles at temperatures in the range below 60° C. in order to achieve an adequate bleaching action. Particularly suitable examples are N- and O-acyl compounds, such as acylated amines, acylated glycolurils or acylated sugar compounds. Preference is given to tetra acetyl ethylene diamine (TAED).

Bleach activators may also be present as co-granulates, which give a better dosage and a better dissolution profile.

The ADW composition may comprise at least 0.01 wt %, at least 0.5 wt %, at least 1.0 wt %, or at least 1.5 wt %, of a bleach activator. It may comprise up to 5.0 wt %, up to 4.5 wt %, up to 4.0 wt %, up to 3.5 wt %, up to 3.0 wt %, or up to 2.5 wt %, of a bleach activator. In an embodiment, it comprises from 0.01 wt % to 1 wt %, more preferably from 0.02 wt % to 0.5 wt %, most preferably from 0.02 wt % to 0.1 wt % of a bleach activator.

The ADW composition as hereinbefore described may optionally further comprise from 0.005 to 0.1 wt % of a bleach catalyst selected from the salts of manganese, iron, cobalt, zinc, nickel, titanium or vanadium or mixtures thereof, preferably selected from organic manganese salts, inorganic manganese salts such as Mn-oxalate or organometallic manganese compounds, or mixtures thereof.

An especially preferred bleach catalyst has the following formula

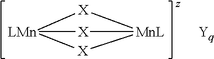

wherein each Mn is individually in the III or IV oxidation state and each x represents a coordinating or bridging species selected from the group consisting of H₂O, O₂²⁻, O²⁻, OH⁻, HO₂⁻, SH⁻, S²⁻, >SO, Cl⁻, N³⁻, SCN⁻, RCOO⁻, NH₂ and NR₃, with R being H, alkyl or aryl, (optionally substituted); L is a ligand which is an organic molecule containing a number of nitrogen atoms which coordinates via all or some of its nitrogen atoms to the manganese centres; z denotes the charge of the complex and is an integer which can be positive or negative; Y is a monovalent or multivalent counter-ion, leading to charge neutrality, which is dependent upon the charge z of the complex; and q=^{z}/[charge Y].

Alternatively, the composition may comprise no bleach activator.

### Alkalinity Source

The ADW composition used in the invention may comprise a source of alkalinity to obtain the desired alkaline pH on dissolution. Typically the alkalinity may be any of the components which are basic; for example, any salt of a strong base and a weak acid. It is especially preferred according to the present invention that the compositions comprise a suitable amount of carbonate or a source of carbonate. Typically the source of alkalinity will be present in an amount of from 1 to 30 wt %, more preferably 5 to 15 wt %.

In the case of alkaline compositions, silicates may be suitable additives. Preferred silicates are sodium silicates such as sodium disilicate, sodium metasilicate and crystalline phyllosilicates.

### Foam Control Agent

The ADW detergent composition used in the present invention may further comprise one or more foam control agents. Suitable foam control agents for this purpose are all those used in this field, such as, for example, silicones, modified silicones, defoaming hydrophobic surfactants and paraffin oil. Foam control agents are preferably present in amounts of less than 5% by weight of the total weight of the detergent.

Suitable paraffin oils are predominantly branched aliphatic hydrocarbons having a number of carbon atoms in the range from 20 to 50. Preference is given to the paraffin oil chosen from predominantly branched-chain C₂₅₋₄₅ species having a ratio of cyclic to noncyclic hydrocarbons of from 1:10 to 2:1, preferably from 1:5 to 1:1.

### Corrosion Inhibitor

The ADW compositions used in the present invention may optionally comprise ingredients known for reducing glassware corrosion.

Non limiting examples of these are silicates, disilicates, zinc and zinc salts, bismuth and bismuth salts, calcium salts, magnesium salts, cationic and amphoteric polymers, and mixtures thereof.

A particularly preferred polymer is polyalkyleneimine, preferably polyethyleneimine (PEI).

In an embodiment, since glassware washed with ADW compositions of the invention already shows a reduced propensity to corrode, the composition comprises no additional inhibitor of glassware corrosion. In an embodiment, the composition comprises no silicate. In an embodiment, the composition comprises no zinc or zinc salt. In an embodiment, the composition comprises no silicate, disilicate, zinc, zinc salt, bismuth, bismuth salt, or polyalkyleneimine. In an embodiment, the total amount of any additional glassware corrosion inhibitors in the composition is no more than 1 wt %, no more than 0.5 wt %, no more than 0.1 wt %, no more than 0.01 wt %, or no more than 0.001 wt %.

The ADW composition according to the invention may also comprise a silver/copper corrosion inhibitor. This term encompasses agents which are intended to prevent or reduce the tarnishing of non-ferrous metals, in particular of silver and copper.

Suitable silver/copper corrosion inhibitors include organic and/or inorganic redox-active substances, for example benzotriazole derivatives. Such benzotriazole derivatives are compounds in which the available substitution sites on the aromatic ring are partially or completely substituted. Suitable substituents are linear or branch-chain C₁₋₂₀-alkyl groups and hydroxyl, thio, phenyl or halogen such as fluorine, chlorine, bromine and iodine. A preferred substituted benzotriazole is tolyltriazole.

Suitable bis-benzotriazoles derivatives are those in which the benzotriazole groups are each linked in the 6-position by a group X, where X may be a bond, a straight-chain alkylene group which is optionally substituted by one or more C₁₋₄-alkyl groups and preferably has 1-6 carbon atoms, a cycloalkyl radical having at least 5 carbon atoms, a carbonyl group, a sulfuryl group, an oxygen atom or a sulfur atom. The aromatic rings of the bis-benzotriazoles may be substituted as defined above for benzotriazole.

Suitable organic redox-active substances are, for example, ascorbic acid, indole, methionine, an N-mono-(C₁-C₄-alkyl)glycine, an N,N-di-(C₁-C₄-alkyl)glycine, 2-phenylglycine or a coupler and/or developer compound chosen from the group consisting of diaminopyridines, aminohydroxypyridines, dihydroxypyridines, heterocyclic hydrazones, aminohydroxypyrimidines, dihydroxypyrimidines, tetraaminopyrimidines, triaminohydroxypyrimidines, diaminodihydroxypyrimidines, dihydroxynaphthalenes, naphthols, pyrazolones, hydroxyquinolines, aminoquinolines, of primary aromatic amines which, in the ortho-, meta- or paraposition, have another hydroxyl or amino group which is free or substituted by C₁-C₄-alkyl or C₂-C₄-hydroxyalkyl groups, and of di- or trihydroxybenzenes.

Suitable inorganic redox-active substances are, for example, metal salts and/or metal complexes chosen from the group consisting of manganese, titanium, zirconium, hafnium, vanadium, cobalt and cerium salts and/or complexes, the metals being in one of the oxidation states II, III, IV, V or VI.

Particularly suitable metal salts and/or metal complexes are chosen from the group consisting of Mn(II) acetate, Mn(II)-oxalate, Mn(II)—SO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂.

Organic and inorganic redox-active substances which are suitable as silver/copper corrosion inhibitors are also mentioned in WO 94/26860 and WO 94/26859, to the contents of which reference is hereby made.

If a silver/copper corrosion inhibitor is present in the detergent composition according to the invention, it is preferably present in an amount of from 0.01 to 5% by weight, particularly preferably in an amount of from 0.1 to 2% by weight, of the total weight.

In an embodiment, the composition comprises no silver/copper corrosion inhibitor. In an embodiment, it comprises no benzotriazole.

### Other Additives

Other customary additives are, for example, dyes and perfumes and optionally in the case of liquid products, preservatives, suitable examples of which are compounds based on isothiazolinone or potassium sorbate.

### Exemplary Compositions

Examples of compositions for use in the present invention include ones that comprise:
(i) from 0.05 to 7.5 wt % of a surfactant; and,
(ii) from 0.1 to 90 wt % of a compound comprising an anion of Formula 1/compound of Formula 2;
   and further wherein the composition comprises a bleach selected from inorganic peroxy compounds, organic peracids and salts derived therefrom.

In another embodiment the composition comprises:
from 0.1 to 90 wt % of a compound comprising an anion of Formula 1/compound of Formula 2;
from 0.05 to 20 wt % of a surfactant;
from 0.01 to 5 wt % of one or more enzymes, preferably enzyme granules; and
from 1 to 30 wt % of bleach, preferably oxygen based bleach; and,
preferably from 0.005 to 0.1 wt % of a bleach catalyst.

In another embodiment the composition comprises:
from 10.0 to 70 wt % of a compound comprising an anion of Formula 1/compound of Formula 2;
from 0.5 to 16 wt % of a surfactant;
from 0.5 to 2 wt % of one or more enzymes, preferably enzyme granules; and
from 5 to 20 wt % of bleach, preferably oxygen based bleach; and,
preferably from 0.005 to 0.1 wt % of a bleach catalyst.

In a further embodiment the ADW detergent composition comprises:
(i) from 10.0 to 50 wt % of a compound comprising an anion of Formula 1/compound of Formula 2;
(ii) from 0.5 to 16 wt % of a non-ionic surfactant;
(iii) from 0.5 to 2 wt % of one or more enzyme granules;
(iv) from 5 to 20 wt % of an oxygen based bleach; and,
(v) from 0.005 to 0.1 wt % of a bleach catalyst.
   pH

Preferably the ADW composition of the present invention yields an alkaline washing medium when contacted with water, and preferably it is an alkaline dishwasher detergent composition. Thus, preferred embodiments of the invention are adapted to produce alkaline washing liquors. In an embodiment, the composition has a pH of at least 7.0, at least 7.5, at least 8.0, at least 8.5, at least 9.0, at least 9.5, or at least 10.0. In an embodiment, it has a pH of up to 12.0, up to 11.5, up to 11.0, or up to 10.5.

Preferably, the composition has a pH in the range of pH 7 to pH 12, preferably pH 8 to 11.5 and more preferably from pH 8.5 to pH 11.

These pH values refer to the composition when dissolved 1:100 (wt:wt, composition:water) in de-ionised water at 20° C., measured using a conventional pH meter.

### Product Format

The detergent compositions of the invention may be in any suitable form such as a liquid, gel, powder, tablet or a capsule made out of a water soluble polymer such as polyvinylalcohol (PVOH). The capsule may be rigid or flexible. It may be single compartment or have more than one compartment. In an embodiment, it is rigid and has more than one compartment.

The composition used in the present invention may, for example, be in the form of a tablet, rod, ball or lozenge. The composition may be provided in a particulate form, loose or pressed to shape or may be formed by injection moulding or by casting or by extrusion. The composition may be encased in a water soluble wrapping, for, example of PVOH or a cellulosic material. The composition may be a gel or a powder. It may also include a pressed pill or gelatine ball, or injection moulded ball.

Where the composition is a liquid/gel, generally the builder compound comprising the anion of Formula 1/compound of Formula 2 will be present in solution within the liquid/gel. According to one embodiment it is especially preferred that the composition is in the form of a tablet as it has been found that the compositions described herein are very suitable for forming a tablet.

Preferably the composition has a solids content of more than 25 wt %, and preferably more than 50 wt %.

### Water Hardness

The ADW compositions described herein may optionally be used with hard or soft water. For instance, in an embodiment the water provided to the automatic dishwashing machine may have a hardness of at least 10° German hardness, more preferably at least 14° German hardness and most preferably at least 21° German hardness.

Preferably, however, soft water is used. Preferably, the water supplied to the automatic dishwashing machine has a hardness of up to 9.0° German hardness, up to 8.0° German hardness, up to 7.0° German hardness, up to 6.0° German hardness, up to 5.0° German hardness, up to 4.0° German hardness, up to 3.5° German hardness, up to 3.0° German hardness, up to 2.5° German hardness, up to 2.0° German hardness, up to 1.5° German hardness, or up to 1.0° German hardness.

### Examples

The composition is described with reference to the following non-limiting Examples. Formulations were prepared as below.

| | Wt % in | Wt % in |
|---|---|---|
| Component | Formulation 1 | Formulation 2 |
| Sodium carbonate | 20.0 | 20.0 |
| Sodium percarbonate | 17.0 | 17.0 |
| Sodium bicarbonate | 8.0 | 8.0 |
| Methyl-glycine-diacetic acid, | 33.7 | 0 |
| sodium salt | | |
| Trisodium-2-methyl-2-(1-oxido- | 0 | 33.7 |
| 1-oxopropan-2-yl) oxypropanoate | | |
| (O-2-methylmalonyllactate) | | |
| TAED | 2.0 | 2.0 |
| Protease (Eraser 3800D) | 0.8 | 0.8 |
| Amylase (Stainzyme Evity 12T) | 0.4 | 0.4 |
| Sulphonated polyacrylate | 5.0 | 5.0 |
| Non-ionic Surfactant | 3.1 | 3.1 |
| PEG 1500 | 2.0 | 2.0 |
| PEG 6000 | 4.0 | 4.0 |
| Other additives (total) | 4.0 | 4.0 |
| Total | 100.0 | 100.0 |
| pH of formulation | 10.3 | 10.3 |

Formulation 1 is a comparative automatic dishwashing tablet. Formulation 2 is an automatic dishwashing tablet of the invention.

### Test Method

In the examples test glasses were washed 25 times in a special endurance test dishwasher (Bosch® SGS3322).

Cleaning Dosage: 20 g of the detergents described above with automatic dosing at the beginning of the cleaning cycle.

Water Hardness in the machine: <1 dGH, central softening through ion exchangers, internal ion exchangers not in operation.

Cleaning program 65° C. (both the cleaning and the rinse cycle were operated at 65° C.).

Water consumption per cycle: 20 litres.

There was no soiling on the glassware tested i.e they were new, unsoiled, glasses.

The test report comprised the following types of glass to provide a variety of different glass types and shapes. The corrosion scores were averaged.

### Clear Glasses

Arc-International (France):

“Longchamp”, No. 3 17 cl Stemglass, lead crystal glass.

“Arcoroc® Elegance”, Wineglass, 14.5 cl.

Nachtmann Bleikristallwerke (Germany):

“Julia Paola”, Weiβweinkelch No. 2

Royal Leerdam (Netherlands)

“Fiori”, 14 cl

Stölze Lausitz GmbH) (Germany):

“Wasserkelch Professional 205 00 11”, 450 ml

### Decorated Glassware

Ritzenhoff & Breker, (Germany):

“Kinderbecher Flirt”,

Leonardo (Germany)

“Latte Macchiato”

Könitz Porzellan GmbH (Germany)

“Longdrink—Saft Escapada Streifen”

The glass corrosion was measured by glass clouding. For this a score was given in accordance with the Table below.

| Evaluation | Damage Impact |
|---|---|
| 1 | Very strong glass clouding, clearly |
| | visible |
| 2 | Strong glass clouding |
| 3 | Slight damage, visible in the light box |
| 4 | Minor glass clouding/hardly visible |
| 5 | No glass clouding |

The scores were averaged across at least seven different glass types and three complete 25 wash cycles. The results were:

Formulation 1 (Comparative example containing MGDA)=2.1
Formulation 2 (ADW formulation of the invention)=3.4

In cleaning tests the formulations were comparable to previous results. These tests demonstrate the effectiveness of compounds comprising the anion of Formula 1 used in ADW compositions as builders in reducing glassware corrosion.

1. A method of automatic dishwashing comprising:
supplying an automatic dishwasher detergent composition to an automatic dishwasher; and
washing glassware in the dishwasher;
wherein the detergent composition comprises a compound comprising an anion of Formula 1: 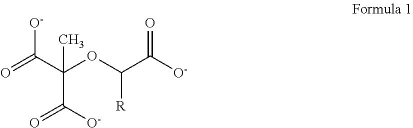
wherein R is selected from the group consisting of: —H; —CH₃; —CₙH₂ₙCH₃; —CₙH₂ₙOH; —CₙH₂ₙCOOH; —CₙH₂ₙCOO—; —CₙH₂ₙSO₃H; CₙH₂ₙSO₃—; —CₙH₂ₙNH₂; —CₙH₂ₙNHR′; —CₙH₂ₙNR′₂; —NHC(═O)—R′; and —CₙH₂ₙPO(OR′)₂;
wherein n>1; and
wherein R′ is H, alkyl or aryl.

2. The method as claimed in claim 1 further comprising supplying water having a hardness of up to 9.0° German hardness to the dishwasher.

3. A method of reducing glassware corrosion during an automatic dishwasher wash cycle comprising use of an automatic dishwasher detergent composition comprising a compound comprising an anion of Formula 1: 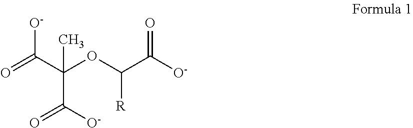
wherein R is selected from the group consisting of: —H; —CH₃; —CₙH₂ₙCH₃; —CₙH₂ₙOH; —CₙH₂ₙCOOH; —CₙH₂ₙCOO—; —CₙH₂ₙSO₃H; CₙH₂ₙSO₃—; —CₙH₂ₙNH₂; —CₙH₂ₙNHR′; —CₙH₂ₙNR′₂; —NHC(═O)—R′; and —CₙH₂ₙPO(OR′)₂;
wherein n≧1; and
wherein R′ is H, alkyl or aryl.

4. The method as claimed in claim 1, wherein R is selected from the group consisting of —CH₃, —CₙH₂ₙCH₃, —CₙH₂ₙOH, and —CₙH₂ₙCOOH.

5. The method as claimed in claim 1, wherein R is —CH₃ and the compound is a trisodium salt.

6. The method as claimed in claim 1, wherein the composition comprises up to 45 wt % of the compound that comprises an anion of Formula 1.

7. The method as claimed in claim 1, wherein the composition comprises no methyl-glycine-diacetic acid or salt thereof.

8. The method as claimed in claim 1, wherein the composition comprises no silicate.

9. The method as claimed in claim 1, wherein the composition further comprises a bleach which is an inorganic peroxy compound, organic peracid, or salt thereof.

10. The method as claimed in claim 1, wherein the composition further comprises up to 7.5 wt % surfactant.

11. The method as claimed in claim 1 further comprising supplying water having a hardness of up to 1.0° German hardness to the dishwasher.

12. The method as claimed in claim 1, wherein the composition further comprises percarbonate.

13. The method as claimed in claim 1, wherein the composition further comprises a non-ionic surfactant.

14. The method as claimed in claim 3, wherein R is —CH₃ and the compound is a trisodium salt.

15. The method as claimed in claim 3, wherein the composition comprises up to 45 wt % of the compound that comprises an anion of Formula 1.

16. The method as claimed in claim 3, wherein the composition comprises no methyl-glycine-diacetic acid or salt thereof.

17. The method as claimed in claim 3, wherein the composition comprises no silicate.

18. The method as claimed in claim 3, wherein the composition further comprises a bleach which is an inorganic peroxy compound, organic peracid, or salt thereof.

19. The method as claimed in claim 3, wherein the composition further comprises up to 7.5 wt % surfactant.

20. The method as claimed in claim 3, wherein the composition further comprises one or both of percarbonate and a non-ionic surfactant.
